(19) United States
(12) Patent Application Publication
(10) Pub. No.: US 2018/0356977 A1
(43) Pub. Date: Dec. 13, 2018

(54) MOBILE TERMINAL AND METHOD FOR PROVIDING USER INTERFACE USING THE SAME, SERVER AND METHOD FOR PROVIDING MOBILE SERVICE USING THE SAME

(71) Applicant: NAVER Corporation, Seongnam-si (KR)

(72) Inventors: Sung Joon Won, Seongnam-si (KR); Seung Yeon Choi, Seongnam-si (KR); Yong Kee Hong, Seongnam-si (KR)

(21) Appl. No.: 16/005,901

(22) Filed: Jun. 12, 2018

(30) Foreign Application Priority Data
Jun. 13, 2017 (KR) 10-2017-0074139

(51) Int. Cl. G06F 3/0488; G06F 3/0482; G06F 3/0346; G06F 3/0484; G06F 3/0481; G06F 9/451

(52) U.S. Cl. CPC G06F 3/04886; G06F 3/0482; G06F 3/0346; G06F 2203/04803; G06F 3/04817; G06F 9/451; G06F 3/04842

(57) ABSTRACT

A method for operating a mobile terminal includes displaying an operation screen on a display unit, displaying a predefined user interface (UI) on the display unit in response to a first user input, determining a task corresponding to a terminal user's intent based on information input to the UI, and performing an action associated with the determined task.

### CROSS-REFERENCE TO RELATED APPLICATIONS

This application claims priority to Korean Patent Application No. 10-2017-0074139 filed on Jun. 13, 2017 in Korean Intellectual Property Office, the entire contents of which is hereby incorporated by reference in its entirety.

### BACKGROUND OF THE INVENTION

### Field of the Invention

The present invention relates to a mobile terminal and a method for providing a user interface using the same, and a server and a method for providing a mobile service using the same. More specifically, the present invention relates to a method and an apparatus capable of remarkably improving user access to functions, information, or app services provided by a mobile terminal that can interwork with a server.

### Description of the Related Art

Terminals may be classified into mobile/portable terminals and stationary terminals according to whether the terminal is movable. The terminals may also be classified into handheld terminals and vehicle mounted terminals according to whether a user can directly carry the terminal.

The functions of a mobile terminal are diversified. For example, a mobile terminal may have a function of data and voice communication, a function of capturing images or video through a camera, a function of voice recording, a function of reproducing music files through a speaker system, and a function of outputting an image or video on a display unit. Some terminals additionally have an electronic game play function or a multimedia player function. In particular, the latest mobile terminals may receive multicast signals that provide visual content such as broadcast, video, or television programs.

As the functions of the mobile terminal become more diversified, the mobile terminal is embodied in the form of a multimedia player that can support complicated functions such as capturing images or video, reproducing music or video files, playing games, receiving broadcast signals, and the like. Accordingly, a menu structure for controlling the operation of the mobile terminal has a complicated hierarchical structure, and the number of icons and widgets for executing a specific function is gradually increasing.

However, since the mobile terminal has to consider mobility or portability, there is a restriction on space allocation for a user interface such as a display or a keypad. In addition, unlike a computer (PC), in the case of a mobile terminal, due to the absence of a multi-switching function (for example, an “ALT+TAB” function) or a multi-window function, when a user wants to perform multitasking, it takes considerable time and effort to exit from a currently running operation screen, search for a new application through a menu screen, find a desired function in the application, and execute the found function.

Therefore, in order to efficiently use various functions or app services provided by the mobile terminal, there is a need to control the operation of the mobile terminal through a novel input/output method instead of a method of sequentially selecting a menu having a complicated structure according to a depth.

### BRIEF SUMMARY OF THE INVENTION

An object of the present invention has been made in an effort to solve the above-described problems and other problems. Another object of the present invention is to provide a mobile terminal which provides a user interface (UI) for executing a specific task quickly and conveniently based on a terminal user's intent, a server, and an operating method thereof

Another object of the present invention is to provide a mobile terminal which infers a terminal user's intent based on information input through a predefined UI and conveniently executes an action, function, or app service associated with the terminal user's intent, a server, and an operating method thereof.

Another object of the present invention is to provide a mobile terminal which infers a terminal user's intent based on information input through a predefined UI and provides one or more action option menus associated with the terminal user's intent, a server, and an operating method thereof.

According to one or more embodiments of the present invention, a method for operating a mobile terminal includes: displaying an operation screen on a display unit; displaying a predefined UI on the display unit in response to a first user input; determining a task corresponding to a terminal user's intent based on information input to the UI; and performing an action associated with the determined task.

According to one or more embodiments of the present invention, a mobile terminal includes: a display unit; a wireless communication unit configured to provide a wireless communication interface with a server; and a control unit configured to display a predefined UI on the display unit in, response to a preset user input, determine a task corresponding to a terminal user's intent based on information input to the UI, and perform an action associated with the determined task.

According to one or more embodiments of the present invention, a method for operating a server includes: transmitting information about a predefined UI to a mobile terminal; receiving information input through the UI from the mobile terminal; inferring a terminal user's intent based on the received input information, and determining a task corresponding to the terminal user's intent; and providing the mobile terminal with a mobile service associated with the determined task.

According to one or more embodiments of the present invention, a server includes: a communication unit configured to transmit information about a predefined UI to a mobile terminal, and receive information input through the UI from the mobile terminal; a processor configured to include a plurality of functional units for perform a plurality of predetermined functions, the functional units including a user intent inferring unit configured to infer a terminal user's intent based on input information received through the communication unit, and determine a task corresponding to the terminal user's intent; and a mobile service providing unit configured to provide the mobile terminal with a mobile service associated with the task determined through the user intent inferring unit.

According to one or more embodiments of the present invention, there is provided a computer-readable recording medium having stored therein a program code causing a computer to perform: displaying an operation screen on a display unit; displaying a predefined UI on the display unit in response to a first user input; determining a task corresponding to a terminal user's intent based on information input to the UI; and performing an action associated with the determined task.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a configuration of a mobile service providing system according to an embodiment of the present invention;

FIG. 2 is a block diagram illustrating a configuration of a server according to an embodiment of the present invention;

FIG. 3 is a block diagram illustrating a configuration of a mobile terminal according to an embodiment of the present invention;

FIG. 4 is a flowchart for describing an operation of a server according to an embodiment of the present invention;

FIG. 5 is a flowchart for describing an operation of a mobile terminal according to an embodiment of the present invention;

FIG. 6 is a diagram for describing a configuration of a user interface according to an embodiment of the present invention;

FIGS. 7A and 7B are reference diagrams for describing an operation of a mobile terminal which displays a user interface, according to an embodiment of the present invention;

FIGS. 8A-8B and 9A-9B are reference diagrams for describing a function of a first display window provided by a user interface;

FIGS. 10A to 10C are reference diagrams for describing a function of an action guide menu provided by a user interface;

FIGS. 11A-11C, 12A-12C and 13A-13C are reference diagrams for describing a function of an action input window provided by a user interface;

FIGS. 14A and 14B are diagrams illustrating a web browser screen according to an embodiment of the present invention;

FIGS. 15 and 16 are reference diagrams for describing a function of an action input window provided on a new tab screen; and

FIG. 17 is a diagram illustrating a web browser screen according to another embodiment of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a term such as “module” and “unit” may be used to refer to elements or components. Use of such terms herein is merely intended to facilitate description of the specification, and the term itself is not intended to give any special meaning or function.

In addition, the term “unit” as used herein refers to a hardware component such as software or hardware component such as FPGA or ASIC, and “unit” performs certain functions. However, “unit” is not limited to software or hardware. A “unit” may be configured in an addressable storage medium or to reproduce one or more processors. Thus, for example, a “unit” includes components, such as software components, object-oriented software components, class components, or task components, processes, functions, attributes, procedures, subroutines, segments of programs codes, drivers, firmware, microcodes, circuits, data, databases, data structures, tables, arrays, and variables. Functions provided in the components and the “units” may be combined with a smaller number of components and “units” or may be separated from additional components and “units.”

Also, while describing the present invention, detailed descriptions about related well-known functions or configurations that may diminish the clarity of the points of the present invention are omitted. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

The present invention provides a method capable of remarkably improving user access to functions, information, or app services provided by a mobile terminal that can interwork with a server.

Hereinafter, various embodiments of the present invention will be described in detail with reference to the accompanying drawings.

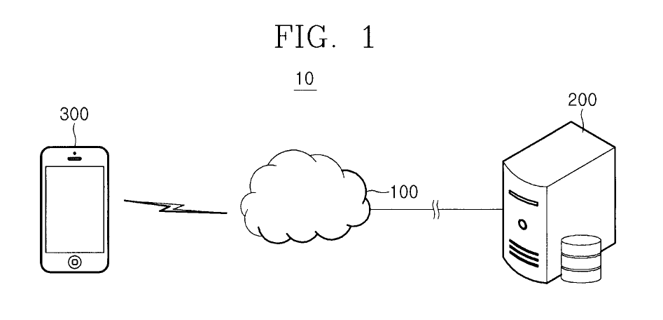

FIG. 1 is a diagram illustrating a configuration of a mobile service providing system according to an embodiment of the present invention.

Referring to FIG. 1, the mobile service providing system 10 according to the present invention may include a communication network 100, a server 200, and a mobile terminal 300.

The mobile terminal 300 and the server 200 may be connected to each other through the communication network 100. The communication network 100 may include a wired network and a wireless network. Specifically, the communication network 100 may include various networks such as Local Area Network (LAN), Metropolitan Area Network (MAN), and Wide Area Network (WAN). In addition, the communication network 100 may include the known World Wide Web (WWW). However, the communication network 100 according to the present invention is not limited to the networks listed above, and may include at least one of a known wireless data network, a known telephone network, and a known wired/wireless television network.

The mobile terminal 300 may provide a mobile service based on information provided from the server 200. For example, when the server 200 is a web server, the mobile terminal 300 may provide a web service based on content provided from the server 200.

The mobile terminal 300 may download and install an application (hereinafter, referred to as a “simple access application” for convenience of explanation) which supports a user interface (UI) for executing a specific function quickly and conveniently based on a terminal user's intent. The mobile terminal 300 may connect to an app store or a play store and download the application, or may download the application through a separate storage medium. In addition, the mobile terminal 300 may download the application through wired/wireless communication with the server 200 or other devices.

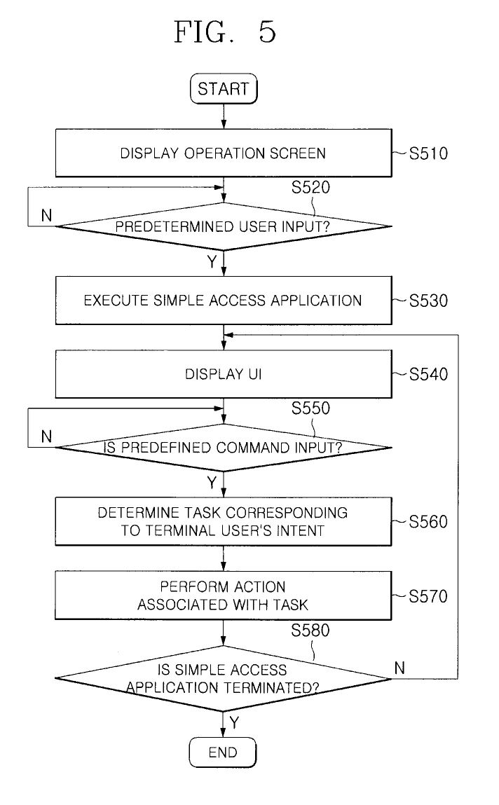

The mobile terminal 300 may execute a previously installed simple access application in response to a predetermined user input (operations S520 and S530 in FIG. 5). When the application is executed, the mobile terminal 300 may display a predefined UI on a display unit. For example, the mobile terminal 300 may display a predefined UI in the form of overlaying on a current operation screen.

When predefined information is input through the UI, the mobile terminal 300 may grasp (or infer) the terminal user's intent based on input information, and directly execute an action, function, or app service associated with the terminal user's intent. In addition, the mobile terminal 300 may grasp (or infer) the terminal user's intent based on information input through the UI, and provide one or more action option menus associated with the terminal user's intent.

The mobile terminal 300 described herein may include a mobile phone, a smart phone, a laptop computer, a digital broadcasting terminal, a personal digital assistant (PDA), a portable multimedia player (PMP), a navigation, a slate PC, a tablet PC, an ultrabook, a wearable device (for example, a smartwatch, a smart glass, or a head mounted display (HMD)), and the like.

The server 200 is a service providing server (or a service provider) and may execute a function of providing a mobile service requested by the mobile terminal 300. For example, when the server 200 is a web server, the server 200 may configure content requested by the mobile terminal 300 in the form of a web page, and provide the mobile terminal 300 with the web page.

The server 200 may provide the mobile terminal 300 with information about a UI for executing a specific function quickly and conveniently based on the terminal user's intent. In addition, the server 200 may grasp (or infer) the terminal user's intent based on user input information received from the mobile terminal 300, and provide the mobile terminal 300 with information about a mobile service associated with the terminal user's intent.

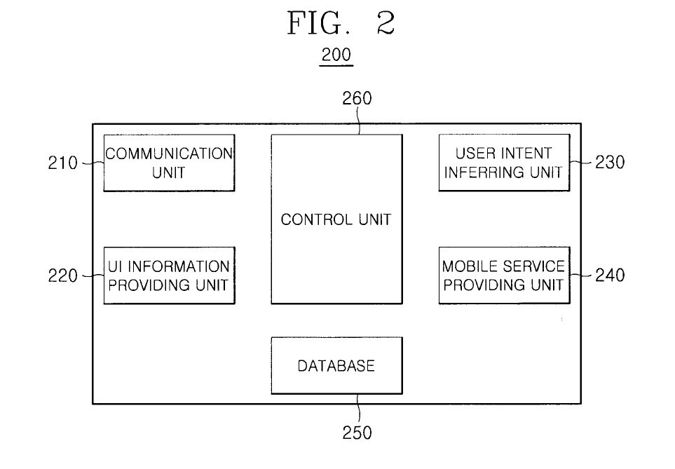

FIG. 2 is a block diagram illustrating the configuration of the server 200 according to an embodiment of the present invention.

Referring to FIG. 2, the server 200 according to an embodiment of the present invention includes a communication unit 210, a UI information providing unit 220, a user intent inferring unit 230, a mobile service providing unit 240, a database 250, and a control unit 260. The server 200 described herein may include more or fewer components than those listed above.

The communication unit 210 may include a wired communication module for supporting wired communication, and a wireless communication module for supporting wireless communication. The wired communication module transmits and receives a wired signal to and from at least one of other server, a base station, and an access point (AP) on a wired communication network established in accordance with technological standards or communication methods for wired communication (for example, Ethernet, Power Line Communication (PLC), Home PNA, IEEE 1394, or the like). The wireless communication module transmits and receives a wireless signal to and from at least one of a base station, an AP, and a relay on a wireless communication network established in accordance with technological standards or communication methods for wireless communication (for example, Wireless LAN (WLAN), Wireless-fidelity (Wi-Fi), Digital Living Network Alliance (DLNA), Global System for Mobile communication (GSM), Code Division Multiple Access (CDMA), Wideband CDMA (WCDMA), Long Term Evolution (LTE), Long Term Evolution-Advanced (LTE-A), or the like).

In the present embodiment, the communication unit 210 may execute a function of transmitting, to the mobile terminal 300, information about a mobile service provided to the mobile terminal 300 and information about a UI displayed on the mobile terminal 300. In addition, the communication unit 210 may execute a function of receiving user input information transmitted by the mobile terminal 300 or information about a mobile service requested by the mobile terminal 300.

The UI information providing unit 220 may execute a function of generating information (that is, screen configuration information) about a UI for executing a specific function quickly and conveniently based on the terminal user's intent, and providing the communication unit 210 with the generated information. The screen configuration information may include not only information about the structure and arrangement of graphic objects constituting the UI but also information about items and content included in the UI. In addition, the screen configuration information may be created by a UI command, and the UI command may be a web script created by various web languages such as Hypertext Markup Language (HTML), Cascading Style Sheets (CSS), Java Script, and eXtensible Markup Language (XML).

The user intent inferring unit 230 may grasp the terminal user's intent based on user input information received from the mobile terminal 300, and determine a specific task based on the terminal user's intent. The user input information may be text information input through the UI of the mobile terminal 300 or menu information selected in the UI, but the present invention is not limited thereto. The terminal user's intent is a type of a task to be currently executed by the terminal user, and may include a message sending task, a schedule setting task, a post sending task, a share task, a place search task, a query task, a memo creation task, a reservation task, a map search task, a wayfinding task, and the like, but the present invention is not limited thereto.

The mobile service providing unit 240 may execute a function of generating information about a mobile service associated with a task to be executed by the terminal user, and providing the communication unit 210 with the generated information. That is, the mobile service providing unit 240 may generate information about an action, function, or app service associated with a task corresponding to the terminal user's intent, and may provide the communication unit 210 with the generated information. In addition, the mobile service providing unit 240 may generate information about one or more action option menus associated with a task corresponding to the terminal user's intent, and provide the communication unit 210 with the generated information.

The database 250 may execute a function of storing information (or data) received from the mobile terminal 300 or other server (not illustrated), information (or data) generated by the server 200, information (or data) to be provided to the mobile terminal 300 or other server, and the like.

The control unit 260 may control an overall operation of the server 200. Furthermore, the control unit 260 may control at least one of the components in combination so as to implement the following various embodiments on the server 200 according to the present invention. In the present embodiment, the control unit 260 may grasp the terminal user's intent and provide the mobile terminal 300 with information about a UI for executing a specific function quickly and conveniently. In addition, the control unit 260 may grasp the terminal user's intent based on user input information received from the mobile terminal 300, and provide the mobile terminal 300 with information about a mobile service associated with the terminal user's intent.

The control unit 260 may be a processor or multiple processors. When the control unit 260 is the processor, the processor may comprise the user intent inferring unit 230 and mobile service providing unit 240.

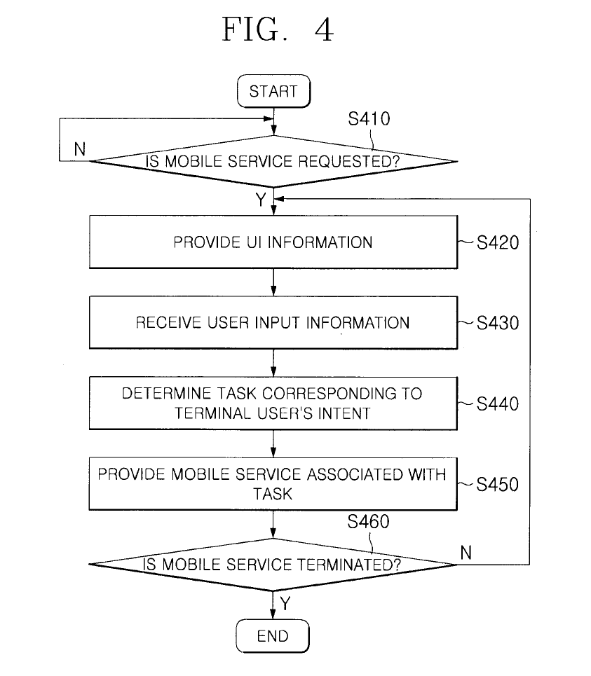

Although it is not shown in drawings, the processor may comprise functional units (i.e. means) for performing S410 to S460 steps of FIG. 4. For example, the processor may comprise UI information providing unit for transmitting information about a predefined user interface (UI) to a mobile terminal, user information acquisition unit for obtain information input through the UI from the mobile terminal, user intent inferring unit for inferring a terminal user's intent based on the received input information, and mobile service providing unit for determining a task corresponding to the terminal user's intent and providing the mobile terminal with a mobile service associated with the determined task.

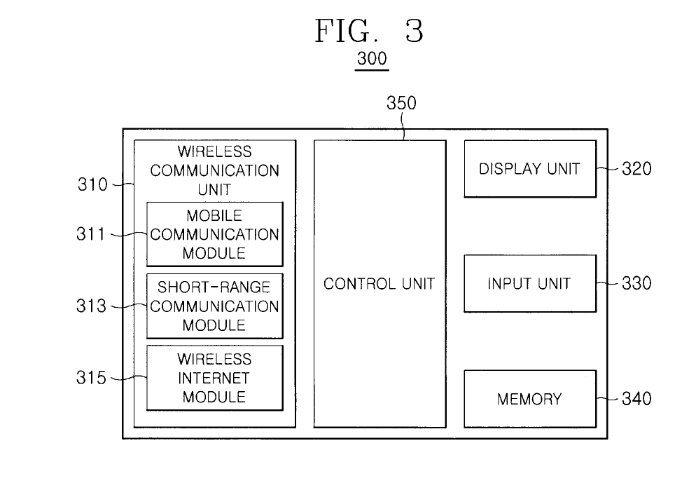

FIG. 3 is a block diagram illustrating the configuration of the mobile terminal 300 according to an embodiment of the present invention.

Referring to FIG. 3, the mobile terminal 300 according to an embodiment of the present invention includes a wireless communication unit 310, a display unit 320, an input unit 330, a memory 340, and a control unit 350. The mobile terminal 300 described herein may include more or fewer components than those listed above.

The wireless communication unit 310 includes a mobile communication module 311, a short-range communication module 313, and a wireless Internet module 315. The mobile terminal 300 may exchange data associated with a “simple access application” with the server 200 through the wireless communication unit 310.

The mobile communication module 311 transmits and receives a wireless signal to and from a neighboring base station on a mobile communication network established in accordance with technological standards or communication methods for mobile communication (for example, Global System for Mobile communication (GSM), Code Division Multiple Access (CDMA), Code Division Multiple Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), or the like).

The short-range communication module 313 is provided for short-range communication and may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies.

The wireless Internet module 315 is a module for wireless Internet connection and transmits and receives a wireless signal on a communication network in accordance with wireless Internet technologies. The wireless Internet technology includes, for example, Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), and the like, and the wireless Internet module 315 transmits and receives data in accordance with at least one wireless Internet technology in the range including up to Internet technologies that are not listed above.

The display unit 320 displays (outputs) information processed by the mobile terminal 300. For example, the display unit 320 may display execution screen information of an application program running on the mobile terminal 300, or UI or graphic user interface (GUI) information according to the execution screen information.

The display unit 320 may form a layer structure with a touch sensor, or may be integrally formed with the touch sensor, thereby implementing a touch screen. The touch screen may function as a user input unit that provides an input interface between the mobile terminal 300 and the user, and may also provide an output interface between the mobile terminal 300 and the user.

The input unit 330 may include a camera or an image input unit for inputting an image signal, a microphone or an audio input unit for inputting an audio signal, and a user input unit for receiving information from the user (for example, a touch key, a push key (mechanical key), or the like). Data acquired by the input unit 330 may be analyzed and processed by a user's control command.

The memory 340 may store data that supports various functions of the mobile terminal 300. The memory 340 may store various application programs or applications running on the mobile terminal 300 and data and commands for the operation of the mobile terminal 300.

In the present embodiment, the memory 340 may store an application that provides a UI for executing a specific function quickly and conveniently based on the terminal user's intent.

The memory 340 may include at least one storage medium selected from among a flash memory, a hard disk, Solid State Disk (SSD), Silicon Disk Drive (SDD), multimedia card micro type memories, card type memories (for example, SD or XD memory), random access memory (RAM), static random access memory (SRAM), read-only memory (ROM), electrically erasable programmable read-only memory (EEPROM), programmable read-only memory (PROM), a magnetic memory, a magnetic disk, and an optical disk.

The control unit 350 may control an operation associated with the application program stored in the memory 340 and an overall operation of the mobile terminal 300. Furthermore, the control unit 350 may control at least one of the components in combination so as to implement the following various embodiments on the mobile terminal 300 according to the present invention.

In the present embodiment, the control unit 350 may run a previously installed simple access application according to a user command or the like, and display a predefined UI on the display unit 320.

The control unit 350 may determine a task matching the terminal user's intent based on information input through the UI, and directly execute an action, function, or app service associated with the determined task. In addition, the control unit 350 may determine a task matching the terminal user's intent based on information input through the UI, and provide one or more action option menus associated with the determined task.

The control unit 350 may be a processor or multiple processors. Although it is not shown in drawings, the processor may comprise functional units (i.e. means) for performing S510 to S580 steps of FIG. 5. For example, the processor may comprise operation screen providing unit for displaying an operation screen on a display unit of the mobile terminal, UI providing unit for displaying a predefined user interface (UI) on the display unit in response to a first user input, task determining unit for determining a task corresponding to a terminal user's intent based on information input to the UI, and action performing unit for performing an action associated with the determined task.

FIG. 4 is a flowchart for describing the operation of the server 200 according to an embodiment of the present invention.

Referring to FIG. 4, the control unit 260 may check whether a signal requesting a specific mobile service (for example, a simple connection service) is received from the mobile terminal 300 (S410). The signal requesting the mobile service may include information about a type of the mobile service, identification information of the mobile terminal 300, information about a current screen of the mobile terminal 300, and the like.

When it is checked in operation S410 that the signal requesting the mobile service is received from the mobile terminal 300, the control unit 260 may generate information about a predefined UI and transmit the generated information to the mobile terminal 300 (S420). At this time, the control unit 260 may generate the information about the UI by reflecting information about the current screen of the mobile terminal 300.

The control unit 260 may receive, from the mobile terminal 300, information input through the UI displayed on the mobile terminal 300 (S430). The information received from the mobile terminal 300 may be text information input through the UI or menu information selected in the UI, but the present invention is not limited thereto.

The control unit 260 may grasp the terminal user's intent based on user input information received from the mobile terminal 300, and determine a specific task based on the terminal user's intent (that is, a task corresponding to the terminal user's intent) (S440). The terminal user's intent is a type of a task to be currently executed by the terminal user, and may include a message sending task, a schedule setting task, a post sending task, a share task, a place search task, a query task, a memo creation task, a reservation task, a map search task, a wayfinding task, and the like, but the present invention is not limited thereto.

Thereafter, the control unit 260 may provide a mobile service associated with the task corresponding to the terminal user's intent. For example, the control unit 260 may generate information about an action, function, or app service associated with the task corresponding to the terminal user's intent, and may provide the mobile terminal 300 with the generated information. In addition, the control unit 260 may generate information about one or more action option menus associated with the task corresponding to the terminal user's intent, and provide the mobile terminal 300 with the generated information.

The control unit 260 may repeat operations S420 to S450 until a signal terminating the mobile service is received from the mobile terminal 300 (S460).

FIG. 5 is a flowchart for describing the operation of the mobile terminal according to an embodiment of the present invention.

Referring to FIG. 5, the control unit 350 may display, on the display unit 320, an operation screen corresponding to a menu or an action selected according to a user command or the like (S510). Examples of the operation screen may include a home screen, a main menu screen, a message screen, an image or video viewer screen, a broadcast screen, a map screen, a web page screen, an SNS screen, and operation screens of various applications.

The control unit 350 may execute a previously installed simple access application in response to a predetermined first user input. The first user input may include an input of touching the home button during a predetermined time, an input of touching the home button as a predetermined pressure, an input of tapping the terminal body a predetermined number of times, an input of moving or rotating the terminal body according to a predetermined pattern, and an input of multi-touching the display unit (for example, a pinch in/out input, a touch-and-drag input, or the like), but the present invention is not limited thereto.

When the application is executed, the control unit 350 may display a predefined UI on the display unit 320 in any situation, regardless of the current operation screen.

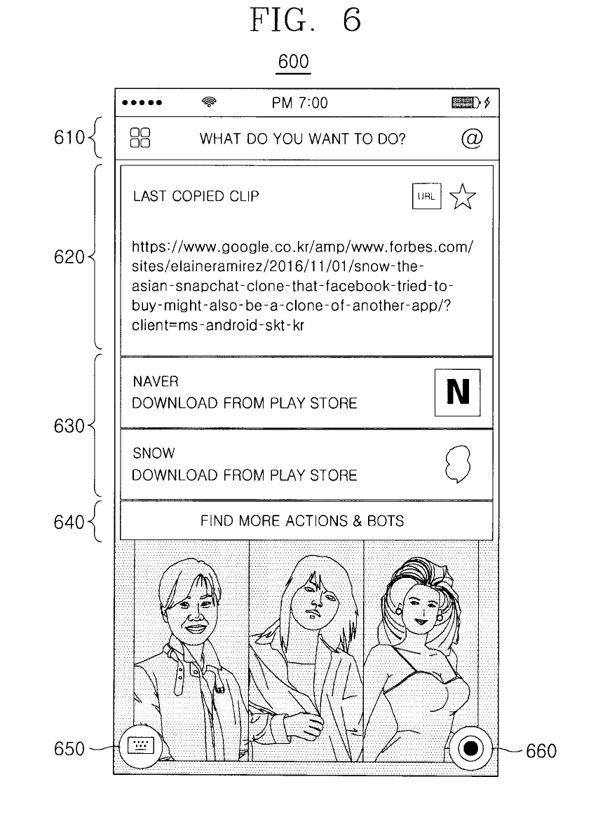

For example, the control unit 350 may display the predefined UI in the form of overlaying on the current operation screen. For example, as illustrated in FIG. 6, a UI 600 displayed in an overlay form may include an action input window 610 for inputting text information indicating the terminal user's intent, a first display window 620 for providing the lastest copied information (e.g. clip information), a second display window 630 for providing information associated with a current operation screen, an additional action search window 640 for additionally searching for information associated with the terminal user's intent, a first icon 650 for displaying a keypad window, and a second icon 660 for selecting a plurality of app icons and/or menu items.

As another example, the control unit 350 may display the predefined UI in the form of a pop-up window on the current operation screen. In this case, the pop-up window may be displayed in an iframe manner.

As another example, the control unit 350 may display a new screen including a predefined UI on the display unit 320, instead of the current operation screen. In this case, the control unit 350 may display, on the display unit 320, an indicator indicating that the simple access application is running.

Items and/or content constituting the predefined UI provided by the mobile terminal 300 may be changed according to the type of the operation screen currently displayed on the display unit 320.

The control unit 350 may check whether first text information (that is, predefined command) indicating the type of the task to be performed by the terminal user and second text information indicating the contents of the task are received through the UI (S550).

When it is checked in operation S550 that at least one of the first text information and the second text information is received through the UI, the control unit 350 may determine the task corresponding to the terminal user's intent based on the input text information (S560). As another example, the control unit 350 may determine the task corresponding to the terminal user's intent based on information provided by the server 200.

The control unit 350 may directly execute an action, function, or app service associated with the task corresponding to the terminal user's intent (S570). In addition, the control unit 350 may provide one or more action option menus associated with the task corresponding to the terminal user's intent.

The action option menus provided by the mobile terminal 300 may be an action option menu corresponding to a function or app service installed on the mobile terminal 300. The action option menus may be an action option menu corresponding to a function or app service not installed on the mobile terminal 300. In the case of the latter, the control unit 350 may execute an operation associated with the task corresponding to the terminal user's intent based on the information received from the server 200.

The control unit 350 may repeat operations S540 to S570 until the currently running simple access application is terminated. Meanwhile, the control unit 350 may terminate the currently running simple access application in response to a predetermined second user input, and cause the predefined UI to disappear on the screen. The second user input may be set equally to the first user input, or may be set differently from the first user input.

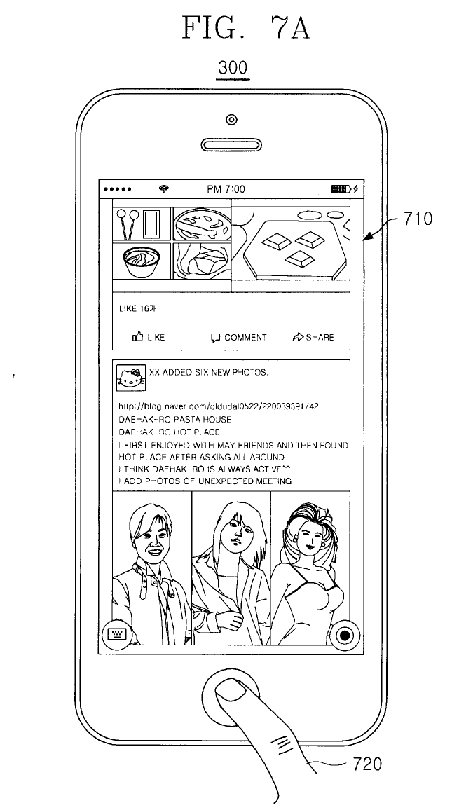

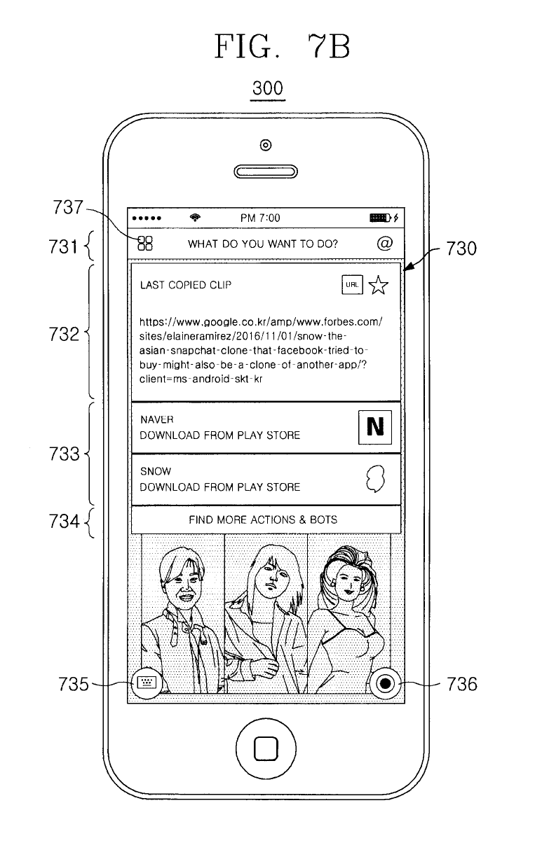

Hereinafter, the operations of the mobile terminal 300 which can conveniently execute the task intended by the terminal user by using the UI will be described in detail with reference to FIGS. 7 to 17.

FIGS. 7A and 7B are reference diagrams for describing the operation of the mobile terminal 300 which displays the UI, according to an embodiment of the present invention.

Referring to FIGS. 7A and 7B, the mobile terminal 300 may display an operation screen 710 corresponding to a specific application on the display unit 320.

When an input 720 of long-touching the home button is received in a state in which the operation screen 710 is displayed, the mobile terminal 300 may execute the previously installed simple access application as a background.

When the application is executed, the mobile terminal 300 may display a predefined UI 730 in the form of overlaying on the current operation screen 710. The UI 730 displayed in the overlay form may include an action input window 731, a first display window (or a first display region) 732, a second display window (or a second display region) 733, an additional action search window 734, a first icon 735, a second icon 736, and the like.

The mobile terminal 300 may receive text information indicating the terminal user's intent through the action input window 731. More specifically, the mobile terminal 300 may receive first text information indicating a type of a task corresponding to the terminal user's intent, and second text information indicating the contents of the task.

The action input window 731 displayed on the UI 730 may additionally include an action guide menu 737 for providing action menus indicating the type of the task corresponding to the terminal user's intent. Accordingly, the terminal user may select any one of a plurality of action menus provided in the action guide menu 737, without directly inputting the first text information on the action input window 731.

The mobile terminal 300 may execute a function of providing last information copied by the terminal user and action menus associated with the copied information through the first display window 732.

The mobile terminal 300 may execute a function of providing a variety of information associated with the current operation screen 710 through the second display window 733. That is, the mobile terminal 300 may analyze content (image, text, or the like) displayed on the current operation screen 710, predict a next action of the terminal user, and provide a variety of information based on the prediction result.

In addition, the mobile terminal 300 may analyze content (image, text, or the like) displayed on the current operation screen 710, and provide a variety of information associated with the operation screen 710. For example, as illustrated, the mobile terminal 300 may analyze content displayed on the current operation screen 710, and provide information recommending a download of a specific app on the second display window 733.

The type of the information that can be provided in the second display window 733 may be not only the above-described app download recommendation information but also action menu information, app service information, notification (weather/traffic/place/reservation information, or the like), concierge information, and the like, but the present invention is not limited thereto.

The mobile terminal 300 may provide a function of allowing the terminal user to additionally search for action information associated with a task intended by the terminal user through the additional action search window 734.

When the first icon 735 displayed in one region of the UI 730 is selected, the mobile terminal 300 may execute a function of displaying a keypad window on the display unit 320. When the second icon 736 displayed in one region of the UI 736 is selected, the mobile terminal 300 may provide a function of allowing the terminal user to select a plurality of app icons and/or menu items and performing a multi-task. As another example, when the second icon 736 is selected, the mobile terminal 300 may provide a function of selecting a plurality of app icons and/or menu items and determining a task corresponding to the terminal user's intent.

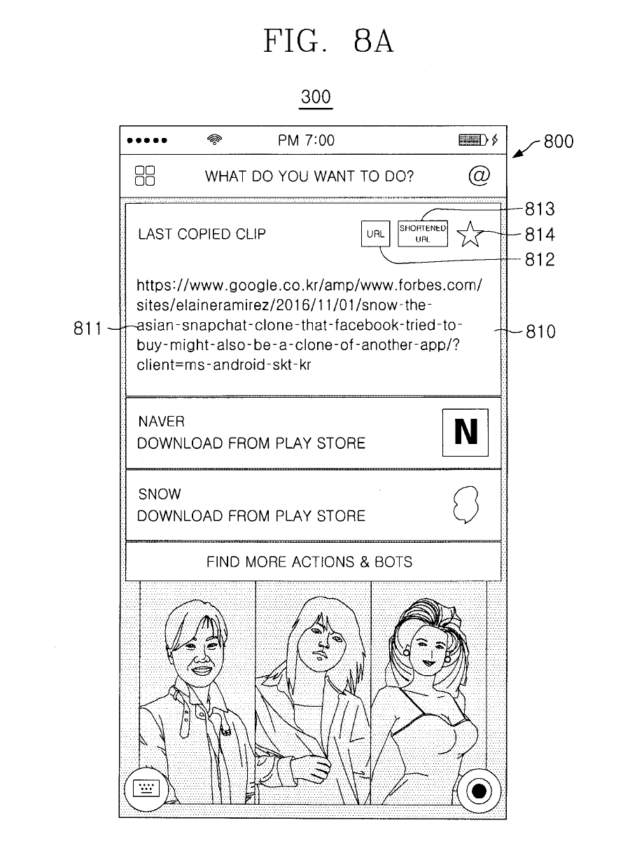

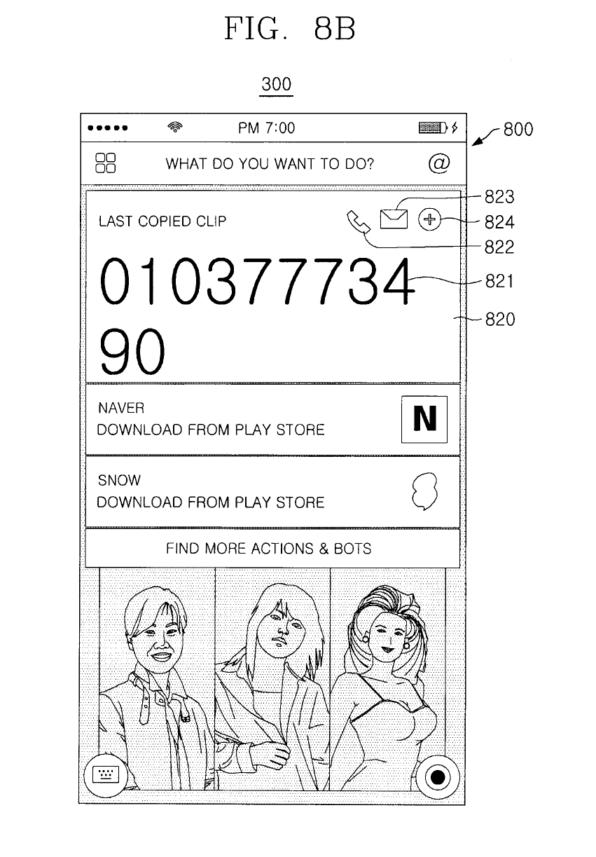

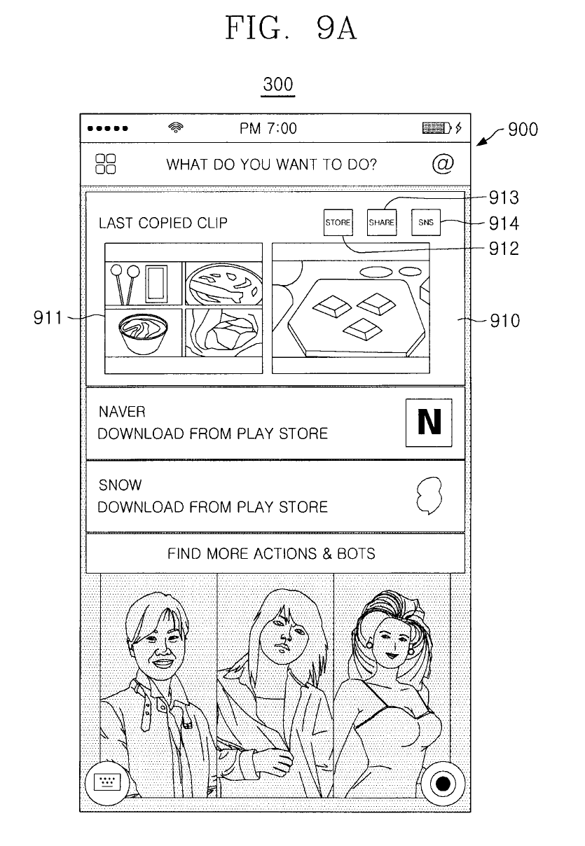

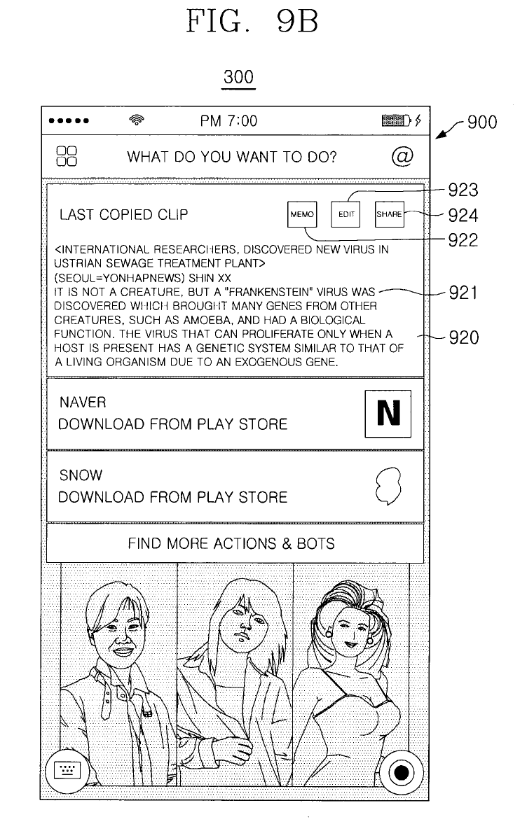

FIGS. 8A-8B and 9A-9B are reference diagrams for describing the function of the first display window provided by the UI.

Referring to FIGS. 8A-8A and 9A-9B, the mobile terminal 300 may display predefined UIs 800 and 900 on the display unit 320 according to a user command or the like.

The mobile terminal 300 may execute a function of providing last information copied by the terminal user and action menus associated with the copied information through the first display window displayed in one region of the Uls 800 and 900.

The type of the information that can be provided in the first display window may include URL information, phone number information, image information, and text information, but the present invention is not limited thereto. The action menus provided in the first display window may be changed according to the type of the copied information.

For example, as illustrated in FIG. 8A, when the information provided in the first display window 810 is URL information 811, the action menu operating in the first display window 810 may be a URL menu 812 for connecting via the URL, a shortened URL menu 813 for converting the URL into a shortened URL, a favorite menu 814 for registering the URL as a bookmark, and a memo menu (not illustrated) for writing the URL to a memo, but the present invention is not limited thereto.

Meanwhile, as illustrated in FIG. 8B, when the information provided in the first display window 820 is phone number information 821, the action menu provided in the first display window 820 may be a call menu 822 for connecting to a phone number, a message menu 823 for sending a message to the phone number, a contact menu 824 for registering the phone number as a contact, and a memo menu (not illustrated) for inputting the phone number to a memo, but the present invention is not limited thereto.

In addition, as illustrated in FIG. 9A, when the information provided in the first display window 910 is image information 911, the action menu provided in the first display window 910 may be a store menu 912 for storing an image, a share menu 913 for sharing the image, and an SNS menu 914 for uploading the image to an SNS, but the present invention is not limited thereto.

In addition, as illustrated in FIG. 9B, when the information provided in the first display window 920 is text information 921, the action menu provided in the first display window 920 may be a memo menu 922 for inputting the text to a memo, an edit menu 923 for editing the text, a share menu 924 for sharing the text, a translation menu (not illustrated) for translating the text, and a post menu (not illustrated) for posting the text, but the present invention is not limited thereto.

Meanwhile, as another example, when displaying an action menu associated with the lastest copied information, the mobile terminal 300 may assign priorities to the action menus associated with the mobile service provided by the predetermined server 200.

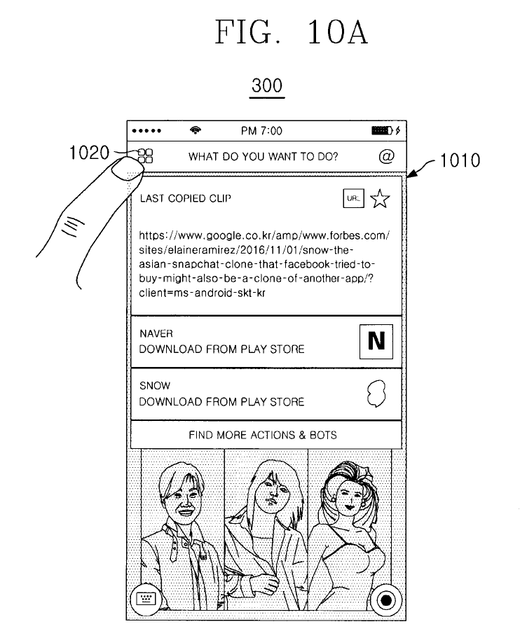

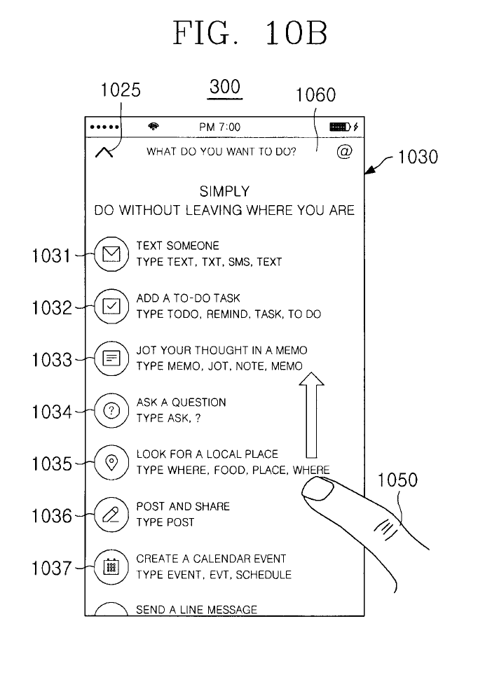

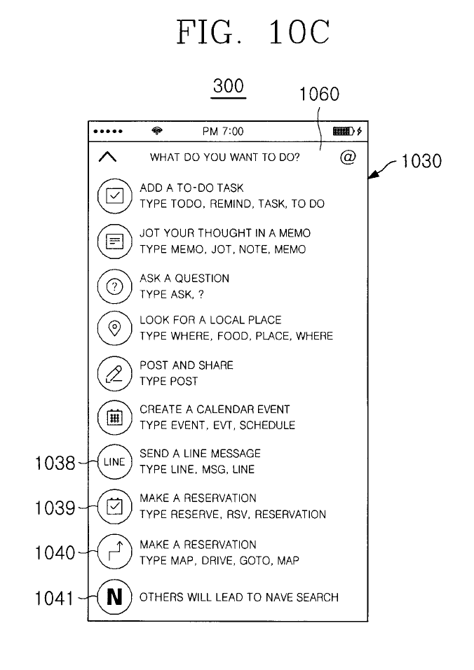

FIGS. 10A to 10C are reference diagrams for describing the function of the action guide menu provided by the UI.

Referring to FIGS. 10A to 10C, the mobile terminal 300 may display a predefined UI 1010 on the display unit 320 according to a user command or the like.

When an action guide menu 1020 displayed at the upper end of the display unit 320 is selected, the mobile terminal 300 may display, on the display unit 320, an action menu list 1030 including a plurality of action menus indicating types of tasks corresponding to the terminal user's intent. When a fold menu 1025 displayed at the upper end of the display unit 320 is selected, the mobile terminal 300 may remove the display of the action menu list 1030 and display the original UI 1010 on the display unit 320.

The action menu list 1030 may include a first action menu 1031 indicating a text sending task, a second action menu 1032 indicating a to-do addition task, a third action menu 1033 indicating a memo creation task, a fourth action menu 1034 indicating a query task, a fifth action menu 1035 indicating a place search task, a sixth action menu 1036 indicating a post and share task, a seventh action menu 1037 indicating a schedule registration task, an eighth action menu 1038 indicating a message sending task, a ninth action menu 1039 indicating a reservation task, a tenth action menu 1040 indicating a wayfinding task, and an eleventh action menu 1041 providing a function set by default when there is no task that the terminal user finds, but the present invention is not limited thereto.

The action menus 1031 to 1041 may each include a unique icon indicating the task, and one or more pieces of text information (that is, predefined commands) indicating the task. As examples of the commands, the first action menu 1031 may include “Type text, txt, sms, text”, the second action menu 1032 may include “Type todo, remind, task, todo”, the third action menu 1033 may include “Type memo, jot, note, memo”, the fourth action menu 1034 may include “Type ask, ask, ?”, the fifth action menu 1035 may include “Type where, food, place, where”, the sixth action menu 1036 may include “Type post”, the seventh action menu 1037 may include “Type event, evt, schedule”, the eighth action menu 1038 “Type line, msg, line”, the ninth action menu 1039 may include “Type reserve, rsv, reservation”, and the tenth action menu 1040 may include “Type map, drive, goto, map”.

When a flicking input (not illustrated) or a touch-and-drag input 1050 of the user is received through the display unit 320, the mobile terminal 300 may scroll a screen including the action menu list 1030 in a direction of the flicking input or the touch-and-drag input 1050.

When one of the action menus 1031 to 1041 provided in the action menu list 1030 is selected, the mobile terminal 300 may remove the display of the action menu list 1030 and automatically input one of pieces of text information corresponding to the selected action menu to the action input window 1060. At this time, the mobile terminal 300 may randomly select one of pieces of the text information and input the selected piece of the text information to the action input window 1060. In another embodiment, the input pattern of the terminal user may be trained for a predetermined time, and text information frequently used by the terminal user may be automatically input to the action input window 1060.

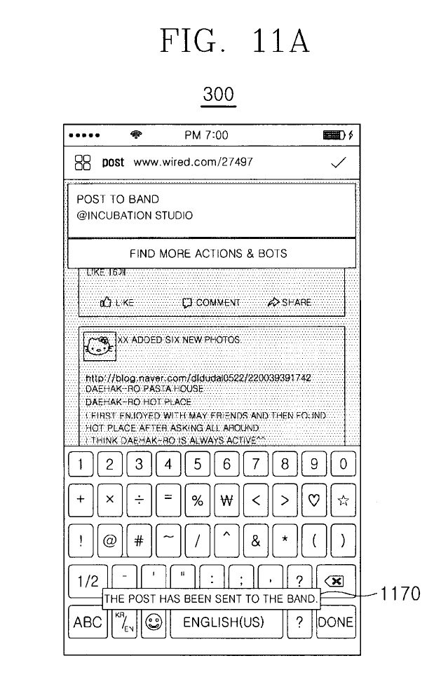

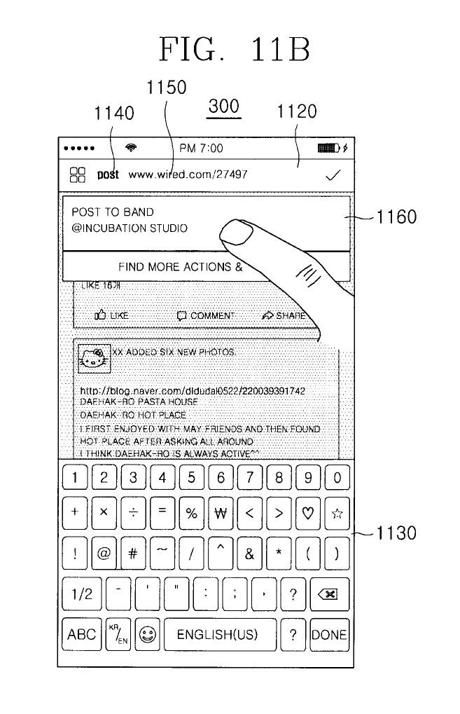

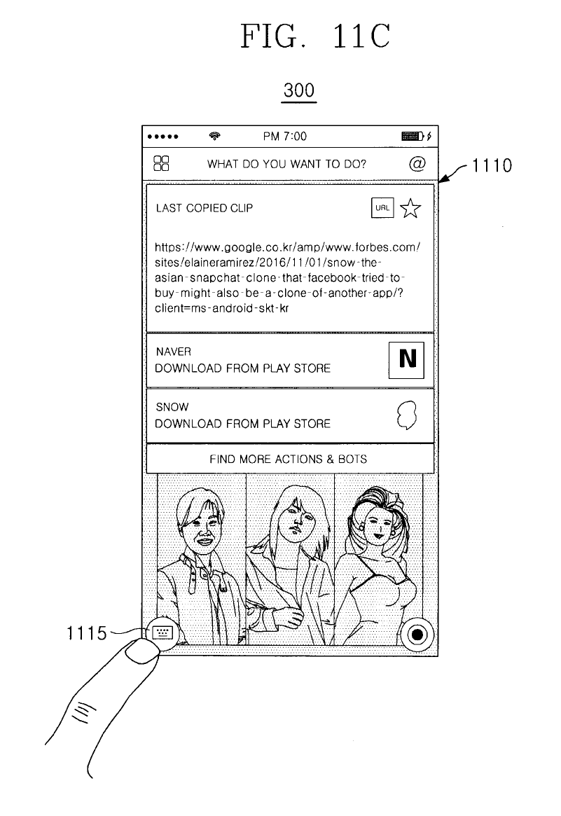

FIGS. 11A-11C, 12A-12C and 13A-13C are reference diagrams for describing the function of the action input window provided by the UI.

Referring to FIGS. 11A to 11C, the mobile terminal 300 may display a predefined UI 1110 on the display unit 320 according to a user command or the like.

When a first icon 1115 displayed in one region of the UI 1110 is selected (FIG. 11C), the mobile terminal 300 may display a keypad window 1130 at the lower end of the display unit 320. The terminal user may input first text information 1140 (for example, “post”) indicating a type of a task to be performed by the terminal user and second text information 1150 (for example, “www.wired.com/27497”) indicating the contents of the task to an action input window 1120 through the keypad window 1130.

When the first text information 1140 and the second text information 1150 are being input or are completely input, the mobile terminal 300 may determine a task corresponding to a terminal user's intent based on the input text information, and provide one or more action option menus associated with the determined task.

The action option menus provided by the mobile terminal 300 may be an action option menu corresponding to a function or app service installed on the mobile terminal 300, or may be an action option menu corresponding to a function or app service not installed on the mobile terminal 300. In the case of the latter, since each application can be operated at the server 200 by using application program interface (API) of each application, the mobile terminal 300 may execute a task intended by the terminal user even when the application is not installed on the mobile terminal 300.

For example, the mobile terminal 300 may display, at the lower end of the action input window 1120, an action option menu 1160 associated with an app service that is to transmit a post. When the action option menu 1160 is selected, the mobile terminal 300 may transmit the second text information 1150 to an app service (for example, “XX band”) corresponding to the selected action option menu 1160. Meanwhile, in another embodiment, when the action option menu is one, the mobile terminal 300 may directly transmit the second text information 1150 to the app service, regardless of the selection of the terminal user.

When the transmission of the post is completed, the mobile terminal 300 may make a notification message 1170 “The post has been transmitted to XX band” disappear after a predetermined time. Accordingly, the terminal user may conveniently transmit a post to a desired app service by using the action input window 1120, without searching for and executing the app service that is to transmit the post.

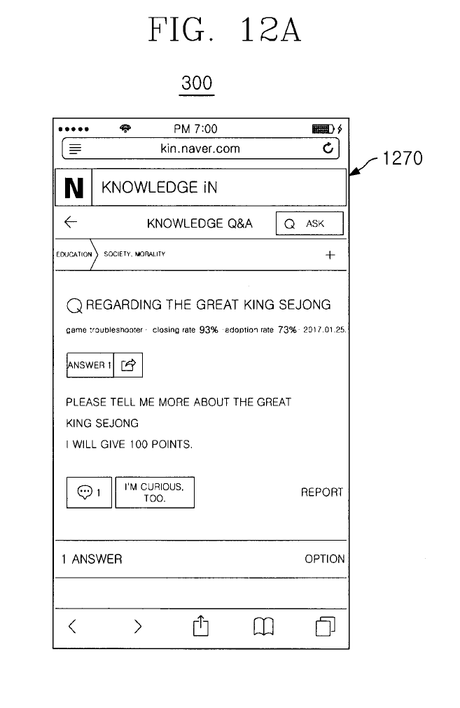

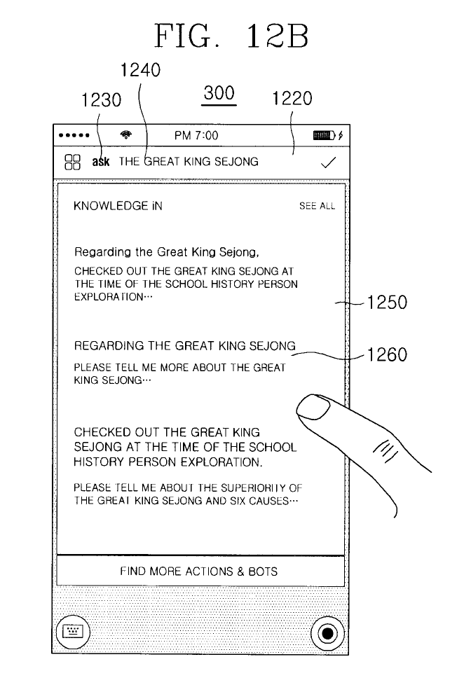

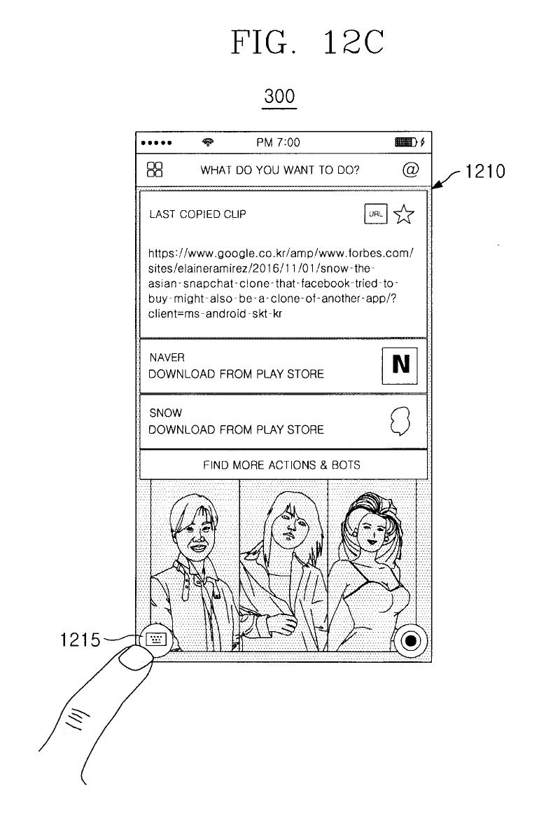

In another embodiment, referring to FIGS. 12A to 12C, the mobile terminal 300 may display a predefined UI 1210 on the display unit 320 according to a user command or the like.

When a first icon 1215 displayed in one region of the UI 1210 is selected (FIG. 12C), the mobile terminal 300 may display a keypad window (not illustrated) at the lower end of the display unit 320. The terminal user may input first text information 1230 (for example, “ask”) indicating a type of a task to be performed by the terminal user and second text information 1240 (for example, “the Great King Sejong”) indicating the contents of the task to an action input window 1220 through the keypad window.

When the first text information 1230 and the second text information 1240 are being input or are completely input, the mobile terminal 300 may determine a task corresponding to a terminal user's intent based on the input text information, and execute an operation associated with the determined task.

For example, the mobile terminal 300 may request a predetermined knowledge search site for an answer to query matter (that is, “the Great King Sejong”), and receive search information about the query matter from the knowledge search site. The mobile terminal 300 may display, at the lower end of the action input window 1220, a search list window 1250 including some search items received from the knowledge search site (that is, items or snippets indicating only some of search contents).

When one item 1260 is selected from among some search items displayed on the search list window 1250, the mobile terminal 300 may connect to the knowledge search site and display, on the display unit 320, an entire search screen 1270 corresponding to the selected item 1260 (that is, a screen displaying the entire search contents). Accordingly, the terminal user may conveniently search for query matter through the action input window 1220, without executing a separate knowledge search site.

The case where the knowledge search service is conveniently performed through the input of “the predefined command (ask) +the query object (the Great King Sejong)” has been described in the present embodiment, but the present invention is not limited thereto. The knowledge search service may be conveniently performed through the input of “the query object (the Great King Sejong)+the predefined query verb (wonder)”.

Although not illustrated, it is obvious to those of ordinary skill in the art that the to-do addition task, the memo creation task, the place search task, the share task, the schedule registration task, the message sending task, the reservation task, the wayfinding task, or the like can be performed in the same or similar manner as the above-described method of performing the post sending task and the query task based on the action input window.

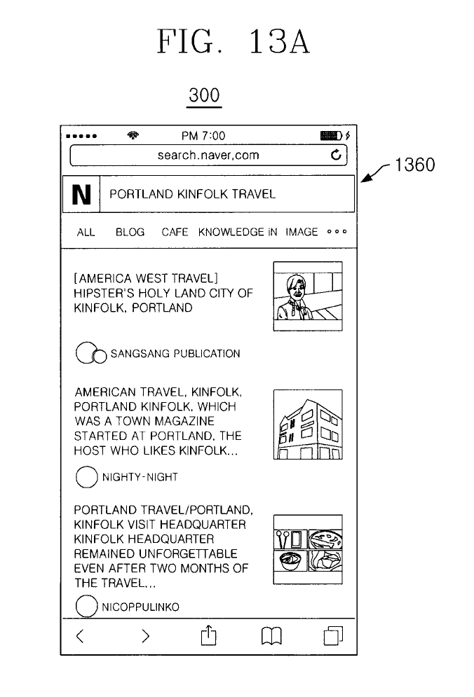

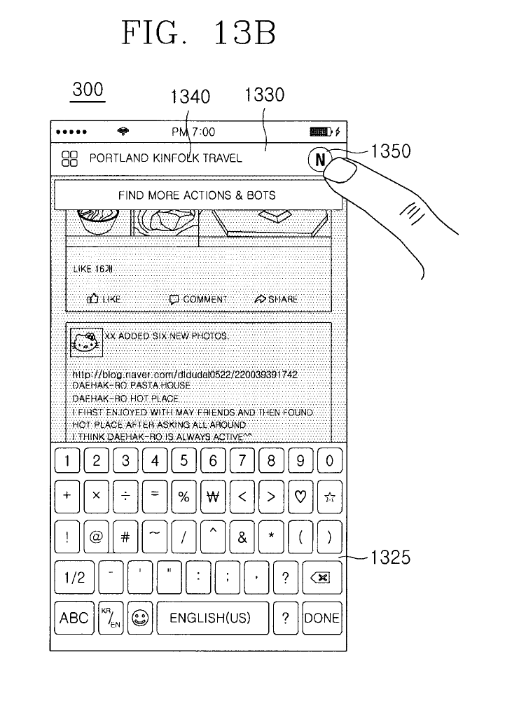

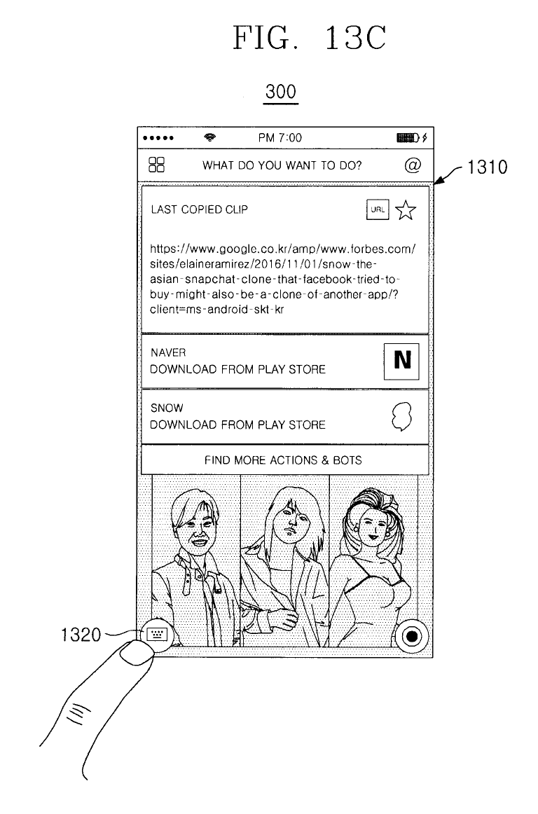

In another embodiment, referring to FIGS. 13A to 13C, the mobile terminal 300 may display a predefined UI 1310 (FIG. 13C) on the display unit 320 according to a user command or the like. When the UI 1310 does not support the task intended by the terminal user, the mobile terminal 300 may provide a function set by default (for example, a general search function) through an action input window 1330.

When a first icon 1320 displayed in one region of the UI 1310 is selected, the mobile terminal 300 may display a keypad window 1325 at the lower end of the display unit 320. The terminal user may input, to the action input window 1330, text information 1340 desired to search for (for example, Portland kinfolk travel”) through the keypad window 1325. Thereafter, when a search icon 1350 is selected, the mobile terminal 300 may request a predetermined portal site for integrated search for the input text information (that is, “Portland kinfolk travel”), receive a search result screen 1360 from the portal site, and display the search result screen 1360 on the display unit 320. Accordingly, the terminal user may conveniently execute the general search function provided in the predetermined portal site by using the action input window 1220, without searching for and executing a separate portal site.

Meanwhile, the case where the predefined UI is provided in the form of overlaying on the operation screen of the mobile terminal has been described in the present embodiment, but the present invention is not limited thereto. Therefore, it is obvious to those of ordinary skill in the art that the UI is implemented through the web browser screen provided by the mobile terminal 300.

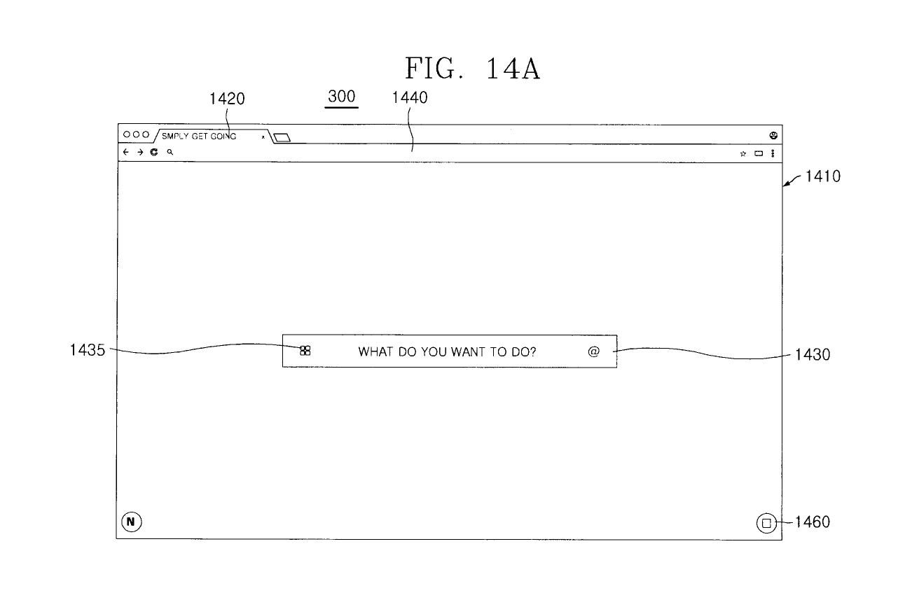

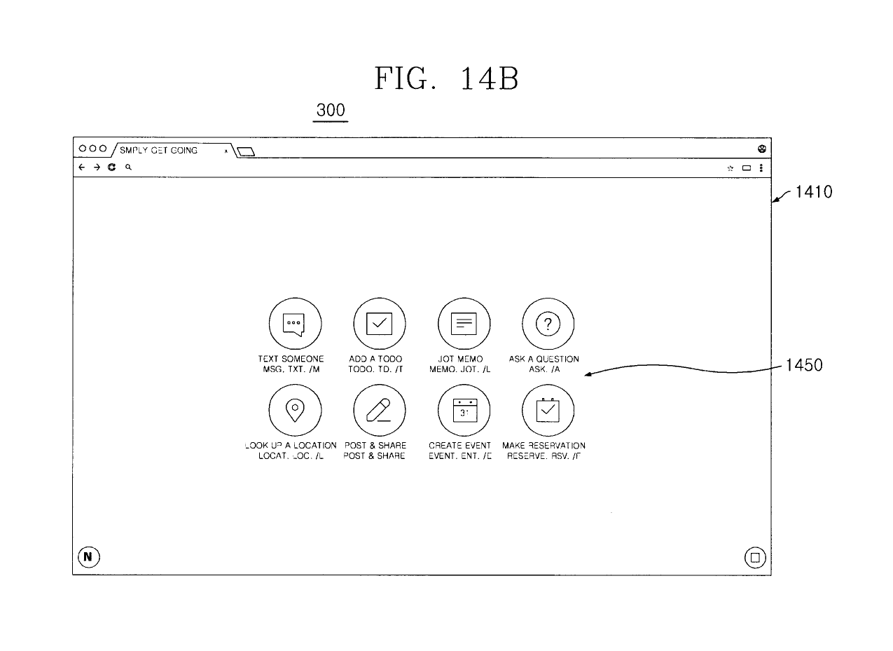

FIGS. 14A and 14B are diagrams illustrating a web browser screen according to an embodiment of the present invention.

Referring to FIGS. 14A and 14B, the mobile terminal 300 may display a web browser screen 1410 on the display unit 320 by driving a web browser according to a user command or the like. The web browser may be Chrome, Internet explorer, Safari, Opera, or the like. More preferably, the web browser may be Chrome.

In the present embodiment, a UI for executing a specific task quickly and conveniently based on a terminal user's intent may be implemented through a new tab of the web browser screen 1410.

A new tab screen 1420 displayed on the mobile terminal 300 may include an action input window 1430 for inputting text information indicating a terminal user's intent, and an address input window 1440 for inputting URL information. In addition, the new tab screen 1420 may additionally include an icon 1460 for displaying a keypad window.

The action input window 1430 may additionally include an action guide menu 1435 for providing action menus indicating a type of a task corresponding to the terminal user's intent. In addition, the address input window 1440 may receive text information indicating the terminal user's intent as well as URL information from the terminal user.

When the action guide menu 1435 displayed on the action input window 1430 is selected, the mobile terminal 300 may display, on the display unit 320, an action menu list 1450 indicating the type of the task corresponding to the terminal user's intent.

The action menu list 1450 may include a first action menu indicating a text sending task, a second action menu indicating a to-do addition task, a third action menu indicating a memo creation task, a fourth action menu indicating a query task, a fifth action menu indicating a place search task, a sixth action menu indicating a post and share task, a seventh action menu indicating an event creation task, and an eighth action menu indicating a reservation task, but the present invention is not limited thereto.

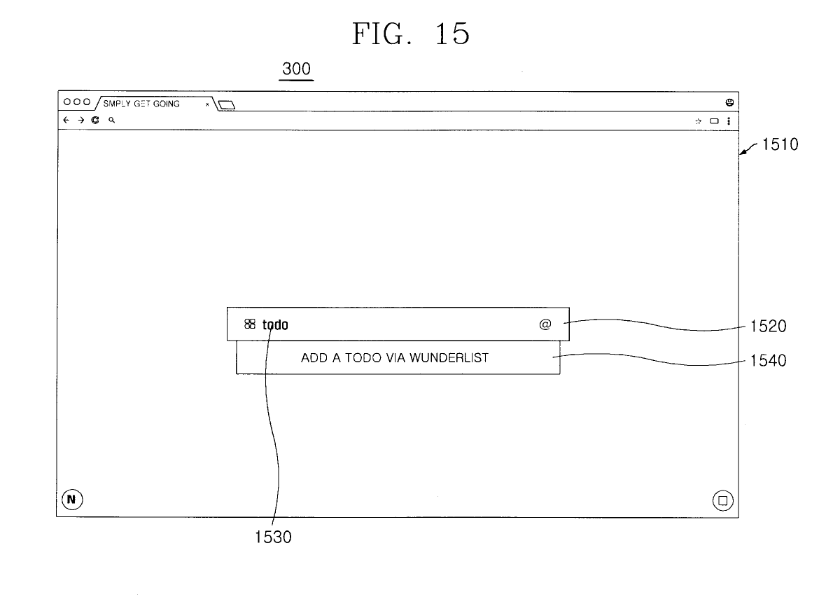

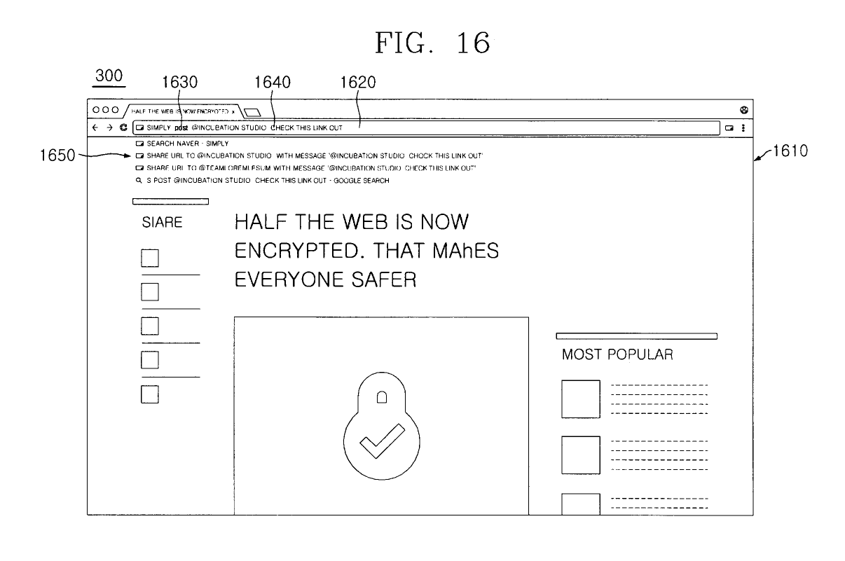

FIGS. 15 and 16 are reference diagrams for describing a function of an action input window provided on a new tab screen.

Referring to FIG. 15, when a predefined command 1530 (for example, “todo”) is input through an action input window 1520 displayed on a new tab screen 1510, a mobile terminal 300 may determine a task corresponding to a terminal user's intent based on input text information, and provide an action option menu 1540 associated with the determined task. For example, the mobile terminal 300 may display, at the lower end of the action input window 1520, an action option menu 1540 associated with a to-do addition task.

In another embodiment, referring to FIG. 16, when first text information 1630 (for example, “post”) indicating a type of a task to be performed by a terminal user and second text information 1640 (for example, “@incubation studio check this think out”) are input through an address input window 1620, the mobile terminal 300 may determine a task corresponding to a terminal user's intent based on input text information, and provide one or more action option menus 1650 associated with the determined task. For example, the mobile terminal 300 may display, at the lower end of the address input window 1620, one or more action option menus 1650 associated with a post sending task.

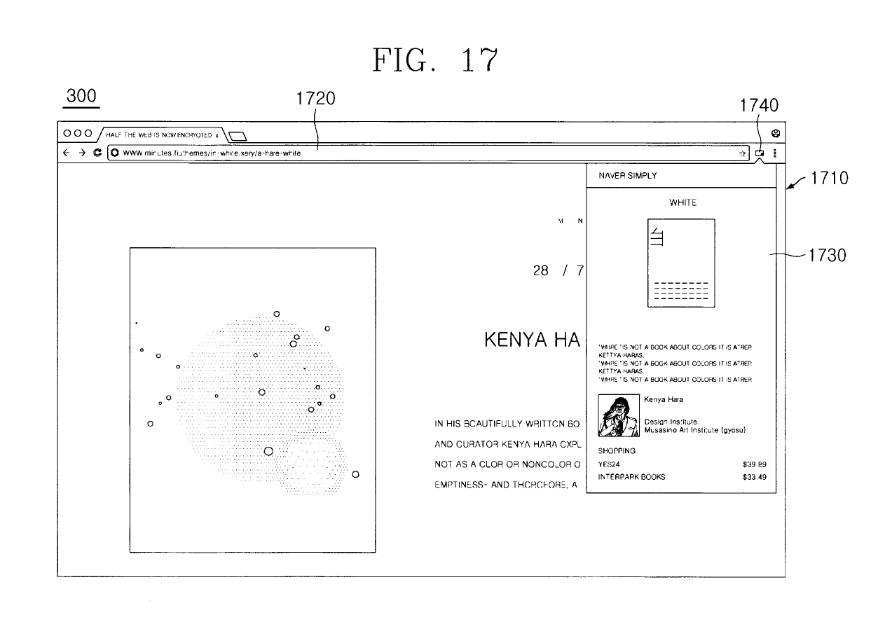

FIG. 17 is a diagram illustrating a web browser screen according to another embodiment of the present invention.

Referring to FIG. 17, the mobile terminal 300 may display a web browser screen 1710 on the display unit 320 by driving a web browser according to a user command or the like.

In the present embodiment, a UI for executing a specific task quickly and conveniently based on a terminal user's intent may be implemented in the form of a pop-up window 1730 on the web browser screen 1710.

The mobile terminal 300 may display, on the display unit 320, an indicator 1740 indicating that a simple access application (or a simple access service) is supported through the web browser screen 1710.

The pop-up window 1730 displayed on the mobile terminal 300 may include an action input item for inputting text information indicating a terminal user's intent, a first display item for providing the lastest copied information, and a second display item for providing information associated with the web browser screen 1710.

As described above, the mobile terminal according to the present invention may infer the terminal user's intent based on information input through the predefined UI and quickly and conveniently execute the action, function, or app service associated with the terminal user's intent, thereby providing user convenience differentiated from that of the existing mobile terminal.

In addition, the mobile terminal according to the present invention may infer the terminal user's intent based on information input through the predefined UI and automatically recommend one or more action option menus associated with the terminal user's intent, thereby providing user convenience differentiated from that of the existing mobile terminal.

The above-described present invention may be embodied as computer-readable codes on a program-recorded medium. A computer-readable medium may continuously store a computer-executable program, or may temporarily store the computer-executable program for execution or download. In addition, the medium may be a variety of recording means or storage means in the form of single hardware or a combination of a plurality of hardware, but is not limited to a medium directly connected to any computer system. For example, the medium may be distributed on a network. Examples of the medium may include magnetic media (e.g., a hard disk, a floppy disk, a magnetic tape, etc.), optical media (e.g., CD-ROM, DVD, etc.), magneto-optical media (e.g., a floptical disk, etc.), ROM, RAM, and flash memory, which are configured to store program instructions. Another example of the medium may include a recording medium or a storage medium managed by an app store that distributes applications or a site or a server that supplies or distributes a variety of other software. Therefore, the above description is illustrative and should not be construed as limited in all aspects. The scope of the present invention should be determined by rational interpretation of the appended claims, and all modifications within the equivalents of the present invention fall within the scope of the present invention.

What is claimed is:

1. A method for operating a mobile terminal, the method comprising:
displaying, by a processor, an operation screen on a display unit of the mobile terminal;
displaying, by the processor, a predefined user interface (UI) on the display unit in response to a first user input;
determining, by the processor, a task corresponding to a terminal user's intent based on information input to the UI; and
performing, by the processor, an action associated with the determined task.

2. The method of claim 1, wherein the displaying of the UI comprises overlaying the UI on the operation screen.

3. The method of claim 1, wherein the first user input is one of an input of long-touching a home button, an input of force-touching the home button, an input of tapping a terminal body, an input of moving or rotating the terminal body according to a predetermined pattern, and an input of multi-touching the display unit.

4. The method of claim 1, wherein the UI comprises at least one of an action input window for inputting text information indicating the terminal user's intent, a first display window for providing the lastest copied information, a second display window for providing information associated with the operation screen, and an additional action search window for additionally searching for information associated with the terminal user's intent.

5. The method of claim 4, wherein the action input window comprises an action guide menu for providing action menus indicating a type of the task corresponding to the terminal user's intent.

6. The method of claim 5, further comprising:
when the action guide menu is selected, displaying an action menu list including a plurality of action menus indicating tasks corresponding to the terminal user's intent; and
when one of the plurality of action menus is selected, automatically inputting text information corresponding to the selected action menu on the action input window.

7. The method of claim 4, further comprising receiving first text information indicating a type of the task corresponding to the terminal user's intent and second text information indicating contents of the task from the action input window.

8. The method of claim 4, further comprising providing one or more action menus associated with the latest copied information through the first display window,
wherein the action menus are changed according to a type of the latest copied information.

9. The method of claim 4, further comprising analyzing content displayed on the operation screen and providing information associated with the operation screen on the second display window,
wherein the information to be provided on the second display window comprises at least one of app download recommendation information, action menu information, app service information, notification information, and concierge information.

10. The method of claim 4, further comprising, when the task corresponding to the terminal user's intent is not supported by the UI, providing a search function using a predetermined search site based on the action input window.

11. The method of claim 1, wherein the performing of the action comprises providing one or more action option menus associated with the determined task, and
the action option menus comprises at least one of an action option menu corresponding to a pre-installed function or an app service and an action option menu corresponding to a function or an app service provided by a server.

12. The method of claim 1, wherein, when the operation screen is a web browser screen, the UI is configured with a new tab screen of the web browser screen.

13. The method of claim 1, further comprising removing the display of the UI in response to a second user input.

14. A mobile terminal comprising:
a display unit;
a wireless communication unit configured to provide a wireless communication interface with a server; and
a control unit configured to display a predefined user interface (UI) on the display unit in response to a predetermined user input, determine a task corresponding to a terminal user's intent based on information input to the UI, and perform an action associated with the determined task.

15. The mobile terminal of claim 14, further comprising a memory configured to store an application that provides a UI for executing a specific function based on the terminal user's intent.

16. A method for operating a server, the method comprising:
transmitting, by a processor, information about a predefined user interface (UD to a mobile terminal;
receiving, by the processor, information input through the UI from the mobile terminal;
inferring, by the processor, a terminal user's intent based on the received input information, and determining a task corresponding to the terminal user's intent; and
providing, by the processor, the mobile terminal with a mobile service associated with the determined task.

17. The method of claim 16, further comprising:
receiving, by the processor, information about an operation screen of the mobile terminal; and
generating, by the processor, information about the UI using the information about the operation screen.

18. The method of claim 16, wherein the providing of the mobile service comprises providing the mobile terminal with information about one or more action option menus associated with the determined task.

19. The method of claim 16, wherein the providing of the mobile service comprises providing the mobile terminal with information about an action, function, or app service associated with the determined task.

20. A server comprising:
a communication unit configured to transmit information about a predefined user interface (UI) to a mobile terminal, and receive information input through the UI from the mobile terminal;
a processor configured to include a plurality of functional units for perform a plurality of predetermined functions, the functional units including,
a user intent inferring unit configured to infer a terminal user's intent based on input information received through the communication unit, and determine a task corresponding to the terminal user's intent; and
a mobile service providing unit configured to provide the mobile terminal with a mobile service associated with the task determined through the user intent inferring unit.
